(19) United States
(12) Patent Application Publication
(10) Pub. No.: US 2022/0135159 A1
(43) Pub. Date: May 5, 2022

(54) METHOD FOR MANUFACTURING VEHICLE

(71) Applicant: TOYOTA JIDOSHA KABUSHIKI KAISHA, Toyota-shi (JP)

(72) Inventors: Shohei ISHIKURA, Nisshin-shi. Aichi-ken (JP); Yuichi HIRANO, Nisshin-shi. Aichi-ken (JP); Shota FUKAYA, Anjo-shi (JP); Kazuki TAKAHASHI, Toyota-shi (JP); Yuhei KOSAKA, Toyota-shi (JP); Shunji INOUE, Okazaki-shi (JP)

(73) Assignee: TOYOTA JIDOSHA KABUSHIKI KAISHA, Toyota-shi (JP)

(21) Appl. No.: 17/499,143

(22) Filed: Oct. 12, 2021

(30) Foreign Application Priority Data
Nov. 5, 2020 (JP) 2020-185278

(51) Int. Cl. B62D 65/02; B23P 19/02; F16B 4/00

(52) U.S. Cl. CPC B62D 65/02; F16B 4/006; B23P 19/02

(57) ABSTRACT

A method for manufacturing a vehicle in which a projected part formed on an assembly surface of one component and a recessed part formed on an assembly surface of the other component are fitted to each other so that the one component and the other component are assembled together is provided. A barb structure protruding outward and towards the root side of the projected part is formed on an outer circumferential surface of the projected part. Alternatively, a barb structure protruding inward and towards the root side of the recessed part is formed on an inner circumferential surface of the projected part and a groove into which the barb structure fits is formed on an outer circumferential surface of the projected part.

### CROSS REFERENCE TO RELATED APPLICATIONS

This application is based upon and claims the benefit of priority from Japanese patent application No. 2020-185278, filed on Nov. 5, 2020, the disclosure of which is incorporated herein in its entirety by reference.

### BACKGROUND

The present disclosure relates to a method for manufacturing a vehicle.

As disclosed in, for instance, Japanese Unexamined Patent Application Publication No. 2019-023036, when a vehicle is manufactured, components thereof are assembled together without having to fasten any screws.

### SUMMARY

The inventors studied a method for manufacturing a vehicle in which a fitting structure having a recessed-projected shape, like assembly blocks for a toy, is formed on an assembly surface on which the components of the vehicle are assembled together by being fitted to each other without having to fasten any screws. By this method, it is possible to, for instance, automate the assembly process in a method for manufacturing a vehicle. However, this method has a problem in that the components in the fitting structure easily comes off from each other after the components are assembled together.

The present disclosure has been made in view of the circumstances described above and provides a method for manufacturing a vehicle in which components of a vehicle can be assembled together without having to fasten any screws and the components in the fitting structure do not easily come off from each other.

A method for manufacturing a vehicle according to an aspect of the present disclosure is

a method for manufacturing a vehicle in which a projected part formed on an assembly surface of one component and a recessed part formed on an assembly surface of the other component are fitted to each other so that the one component and the other component are assembled together, the method including:

forming a barb structure protruding outward and towards the root side of the projected part on an outer circumferential surface of the projected part; and

forming a groove into which the barb structure fits on an inner circumferential surface of the recessed part.

In the method for manufacturing the vehicle according to the aspect of the present disclosure, a barb structure protruding outward and towards the root side of the projected part is formed on an outer circumferential surface of the projected part formed on an assembly surface of the one component, and a groove into which the barb structure fits is formed on an inner circumferential surface of the recessed part formed on the assembly surface of the other component. Therefore, when the one component and the other component are assembled together by fitting the projected part into the recessed part, each barb structure formed on the outer circumferential surface of the projected part fits into each groove formed on the inner circumferential surface of the recessed part. Accordingly, it is possible to make the projected part and the recessed part that are fitted to each other hard to come off from each other. That is, it is possible to provide a method for manufacturing a vehicle in which the components of a vehicle can be assembled together without having to fasten any screws and the components in the fitting structure are hard to come from each other.

A method for manufacturing a vehicle according to another aspect of the present disclosure is

a method for manufacturing a vehicle in which a projected part formed on an assembly surface of one component and a recessed part formed on an assembly surface of the other component are fitted to each other so that the one component and the other one component are assembled together, the method including:

forming a barb structure protruding inward and towards the root side of the recessed part on an inner circumferential surface of the recessed part; and

forming a groove into which the barb structure fits is formed on an outer circumferential surface of the projected part.

In the method for manufacturing the vehicle according to the another aspect of the present disclosure, a barb structure protruding inward and towards the root side of the recessed part is formed on an inner circumferential surface of the recessed part, and a groove into which the barb structure fits is formed on an outer circumferential surface of the projected part formed on the assembly surface of the other component. Therefore, when the one component and the other component are assembled together by fitting the projected part into the recessed part, each barb structure formed on the inner circumferential surface of the recessed part fits into each groove formed on the outer circumferential surface of the projected part. Accordingly, it is possible to make the projected part and the recessed part that are fitted to each other hard to come off from each other. That is, it is possible to provide a method for manufacturing a vehicle in which the components of a vehicle can be assembled to together without having to fasten any screws and the components in the fitting structure are hard to come off from each other.

The projected part may be cooled when the components are to be assembled together. Alternatively, when the components are to be assembled together, the recessed part may be heated. Accordingly, it becomes easy to fit the projected part into the recessed part.

A plurality of the barb structures are arranged in the depth direction of the recessed part or the height direction of the projected part. With this configuration, it is possible to make the projected part and the recessed part that are fitted to each other hard to come off from each other.

According to the present disclosure, it is possible to provide a method for manufacturing a vehicle in which the components of a vehicle can be assembled together without having to fasten any screws and the components in the fitting structure are hard to come off from each other.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a plan view of a component of a vehicle used in a method for manufacturing a vehicle according to a first embodiment;

FIG. 2 is a cross-sectional diagram cut along a line II-II shown in FIG. 1;

FIG. 3 is a cross-sectional diagram showing a state in which the components of a vehicle are assembled together;

FIG. 4 is a cross-sectional diagram showing the components of a vehicle used in a first modified example of the method for manufacturing a vehicle according to the first embodiment;

FIG. 5 is a cross-sectional diagram showing the components of a vehicle used in a second modified example of the method for manufacturing a vehicle according to the first embodiment; and

FIG. 6 is a cross-sectional diagram of the components of a vehicle used in a method for manufacturing a vehicle according to a second embodiment.

### DESCRIPTION OF EMBODIMENTS

Hereinbelow, specific embodiments to which the present disclosure is employed will be described with reference to the drawings. However, the present disclosure is not limited to the embodiments described below. Further, the following description and the attached drawings are shortened and simplified where appropriate to clarify the explanation.

### First Embodiment

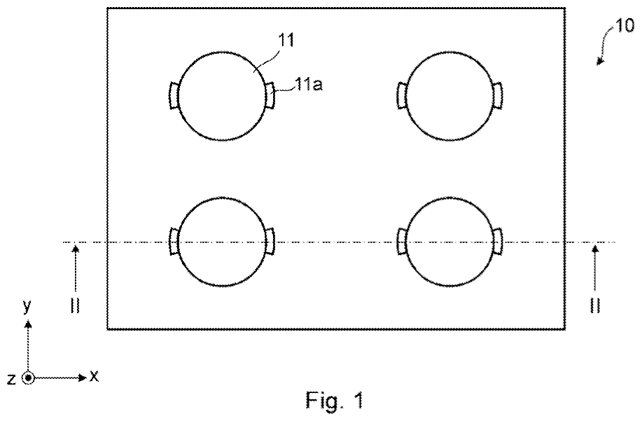

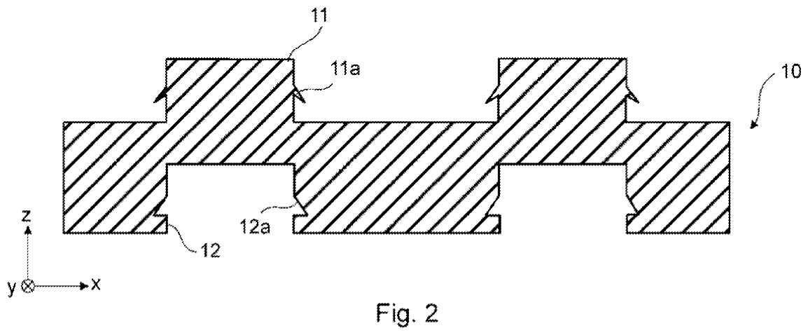

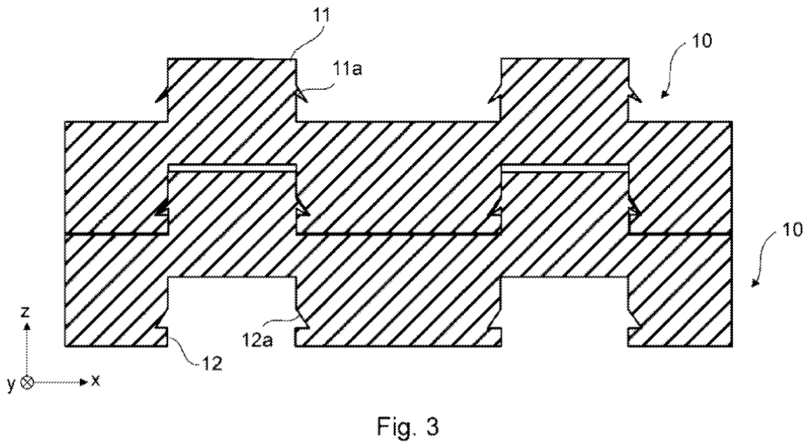

First, a method for manufacturing a vehicle according to a first embodiment will be described with reference to FIGS. 1 to 3. FIG. 1 is a plan view of the components of a vehicle used in the method for manufacturing a vehicle according to the first embodiment. FIG. 2 is a cross-sectional diagram cut along a line II-II shown in FIG. 1. FIG. 3 is a cross-sectional diagram showing a state in which the components of the vehicle are assembled together. Note that as a matter of course, right-handed xyz-orthogonal coordinates are shown in FIG. 1 and other drawings for the sake of convenience in explaining the positional relationship of the structural components to each other. Unless otherwise stated, the z-axis positive-side is the vertical upward direction and the xy plane is the horizontal plane, and this applies to all of the drawings.

A component 10 shown in FIGS. 1 and 2 has a shape similar to an assembly block for a toy. Specifically, as shown in FIG. 1, the component 10 is a plate-like member, and projected parts 11 each having a cylindrical shape are arranged in the x-axis direction and the y-axis direction on the main surface serving as the assembly surface of the one component 10. Further, as shown in FIG. 2, cylindrically recessed parts 12 are formed on the main surface serving as the assembly surface of the other component 10 at positions corresponding to the respective projected parts 11.

As shown in FIG. 3, the projected parts 11 of the one component 10 and the recessed parts 12 of the other component 10 are respectively fitted together whereby the two components 10 are assembled together. Plural pairs of the components 10 are assembled together to form, for instance, a vehicle body. The components 10 are made of, for instance, metal or resin.

As shown in FIGS. 1 and 2, barb structures 11a protruding outward and towards the root side (the z-axis negative direction side) of the projected part 11 are formed on the outer peripheral surface of the projected part 11. In the example shown in FIG. 1, the barb structures 11a are formed on both ends of each projected part 11 in the x-axis direction thereof. That is, two barb structures 11a are formed on each projected part 11. Each barb structure 11a is deformable so as to come in close contact with the outer peripheral surface of the projected part 11 when an external force is applied thereto and is also deformable so as to re-project outward when it is released from the external force. As described above, each barb structure 11a is elastically deformable at the root part thereof.

Note that three or more barb structures 11a may be formed on each projected part 11. Alternatively, the barb structures 11a may be circularly formed along the whole circumference of the outer peripheral surface of each projected part 11.

Further, as shown in FIGS. 2 and 3, a groove 12a into which the barb structure 11a fits is formed on the inner circumferential surface of each of the recessed parts 12. In the example shown in FIG. 2, the groves 12a each having a triangular shape in cross-section are circularly formed along the whole circumference of the inner peripheral surface of each recessed part 12. Here, the width of each groove 12a in the depth direction (the z-axis direction) of the recessed part 12 is made larger than the width of the root part of each barb structure 11a so as to facilitate fitting of each barb structure 11a into the respective groove 12a. Note that each groove 12a may be formed only at a position corresponding to the barb structure 11a formed on the inner circumferential surface of the recessed part 12.

As shown in FIG. 3, by fitting, into the recessed part 12 of one component 10, the projected part 11 of the other component 10, the two components 10 are assembled together. When the projected part 11 is to be fitted into the recessed part 12, each barb structure 11a formed on the outer circumferential surface of the projected part 11 bends so as to come in close contact with the outer circumferential surface of the projected part 11. Then, after fitting of the projected part 11 into the recessed part 12 is completed, each barb structure 11a formed on the outer circumferential surface of the projected 11 fits into the respective groove 12a formed on the inner circumferential surface of the recessed part 12, and each barb structure 11a separates from the outer circumferential surface of the projected part 11 and projects outward again.

It is difficult to pull the projected part 11 out from the recessed part 12 that are fitted to each other since the barb structures 11a of the projected part 11 that fit into the respective grooves 12a of the recessed part 12 function as stoppers. That is, it is possible to make the projected part 11 and the recessed part 12 that are fitted to each other hard to come off from each other.

Here, when the projected part 11 of the other component 10 is to be fitted into the recessed part 12 of the one component 10, the projected part 11 of the other component 10 may be, for instance, heat-shrunk by cooling using liquid nitrogen or the like. By this configuration, it becomes easy to fit the projected part 11 of the other component 10 into the recessed part 12 of the one component 10. Alternatively, when the projected part 11 of the other component 10 is to be fitted into the recessed part 12 of the one component 10, the recessed part 12 of the other component 10 may be thermally expanded by heating. By this configuration, it becomes easy to fit the projected part 11 of the other component 10 into the recessed part 12 of the one component 10.

As described above, in the method for manufacturing a vehicle according to the first embodiment, the barb structures 11a protruding outward and towards the root side of the projected part 11 are formed on the outer peripheral surface of the projected part 11 formed on the assembly surface of the one component 10. Further, the grooves 12a into which the barb structures 11a respectively fit are formed on the inner circumferential surface of the recessed part 12 formed on the assembly surface of the other component 10.

Therefore, when the one component 10 and the other component 10 are assembled together by fitting the projected part 11 into the recessed part 12, each barb structure 11a formed on the outer circumferential surface of the projected part 11 fits into the respective groove 12a formed on the inner circumferential surface of the recessed part 12. Accordingly, it is possible to make the projected part 11 and the recessed part 12 that are fitted to each other hard to come off from each other.

That is, in the method for manufacturing a vehicle according to the first embodiment, it is possible to assemble the components of the vehicle together without having to fasten any screws and the components in the fitting structure are hard to come off from each other.

Note the projected parts 11 do not need to be cylindrical and may be prismatic. The recessed part 12 does not need to be cylindrically recessed and may have any shape as long as it fits with the projected part 11. Further, the components to be assembled together do not need to have the same shape.

Further, the illustrated component 10 has both the projected part 11 and the recessed part 12 formed thereto like an assembly block for a toy, however either only the projected part 11 or the recessed part 12 may be formed in one component 10. That is, any configuration may be employed as long as the projected parts formed on the assembly surface of the one component and the recessed parts formed on the assembly surface of the other component are fitted to each other so that one component and the other component are assembled together. Therefore, each component may be, for instance, a large module or the like.

### First Modified Example of First Embodiment

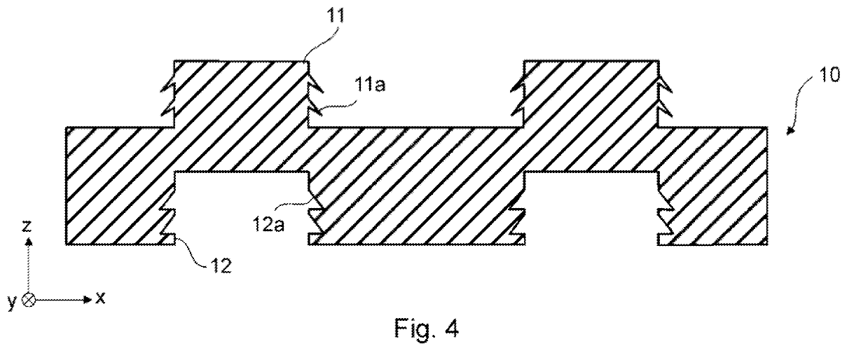

Next, a method for manufacturing a vehicle according a first modified example of the first embodiment will be described with reference to FIG. 4. FIG. 4 is a cross-sectional diagram showing components of a vehicle used in the first modified example of the method for manufacturing a vehicle according to the first embodiment. FIG. 4 is a cross-sectional diagram corresponding to FIG. 2.

As shown in FIG. 4, two or more barb structures 11a are arranged vertically in the height direction (the z-axis direction) of the projected part 11 on the outer circumferential surface of each projected part 11 of the component 10 according to the first embodiment.

On the other hand, as shown in FIG. 4, two or more grooves 12a are arranged vertically in the depth direction (the z-axis direction) of the recessed part 12 on the inner circumferential surface of each recessed part 12 of the component 10.

Note that the number of the barb structures 11a and the number of the grooves 12a that are formed may be three or more, respectively.

In the method for manufacturing a vehicle according to the modified example of the first embodiment, when the one component 10 and the other component 10 are assembled together by fitting the projected part 11 into the recessed part 12, each barb structure 11a formed on the outer circumferential surface of the projected part 11 fits into the respective one of the two grooves 12a formed on the inner circumferential surface of the recessed part 12. Therefore, in the method for manufacturing a vehicle according to the first modified example of the first embodiment, it is possible to make the projected part 11 and the recessed part 12 that are fitted to each other harder to come off from each other than those in the method for manufacturing a vehicle according to the first embodiment.

Other configurations are the same as those of the first embodiment shown in FIGS. 1 to 3 and thus detailed explanations thereof are omitted.

### Second Modified Example of First Embodiment

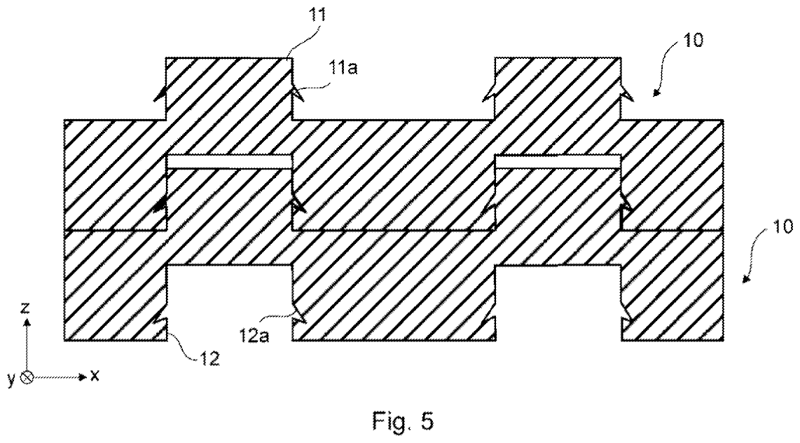

Next, a method for manufacturing a vehicle according a second modified example of the first embodiment will be described with reference to FIG. 5. FIG. 5 is a cross-sectional diagram showing components of a vehicle used in the second modified example of the method for manufacturing a vehicle according to the first embodiment. FIG. 5 is a cross-sectional diagram corresponding to FIG. 3.

In the examples shown in FIGS. 2 and 3, the width of each groove 12a in the depth direction (the z-axis direction) of the recessed part 12 is made larger than the width of the root part of each barb structure 11a so as to facilitate fitting of the barb structure 11a into the groove 12a. On the other hand, the shape of the barb structure 11a in xz cross-section and the shape of the groove 12a in xz cross-section are roughly the same in the component 10 according to the second modified example shown in FIG. 5. Further, the depth of the recessed part 12 is greater than the height of the projected part 11 as compared to the recessed part and the projected part shown in FIGS. 2 and 3. Note that from the viewpoint of facilitating fitting of the barb structure 11a into the groove 12a by elastically deforming the projected part 11, the depth of the recessed part 12 may be the same as the height of the projected part 11, or may be even greater than that of the projected part 11. The component 10 according to the second modified example is made of, for instance, an elastically deformable material such as rubber. When assembling the components 10 according the second modified example together, the projected part 11 is temporarily pushed deeply into the recessed part 12, and at the timing when the projected part 11 returns to the open side of the recessed part 12, the barb structure 11a fits into the groove 12a. Other configurations are the same as those of the first embodiment shown in FIGS. 1 to 3 and thus detailed explanations thereof are omitted.

### Second Embodiment

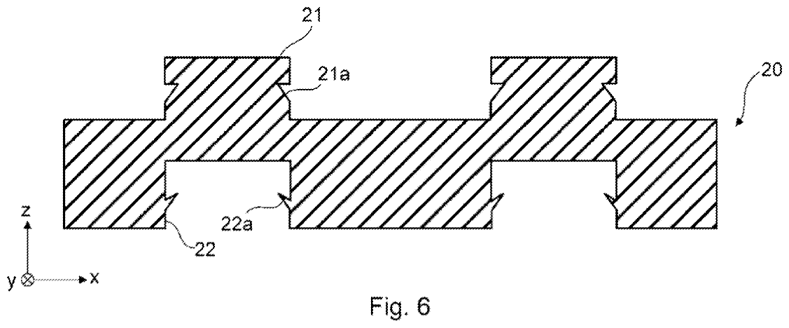

Next, a method for manufacturing a vehicle according a second embodiment will be described with reference to FIG. 6. FIG. 6 is a cross-sectional diagram of the components of a vehicle used in the method for manufacturing a vehicle according to the second embodiment. FIG. 6 is a cross-sectional diagram corresponding to FIG. 2.

As shown in FIG. 6, the cylindrical projected parts 21 are formed on one main surface of the component 20 serving as the assembly surface in the similar manner as those of the component 10 according to the first embodiment. Further, the cylindrically recessed parts 22 are formed on the main surface serving as the assembly surface of the other component 20 at positions corresponding to the respective projected parts 21.

Then, as shown in FIG. 6, the projected barb structures 22a protruding inward and towards the root side (the z-axis positive side) of the recessed part 22 are formed on the inner circumferential surface of the recessed part 22. Further, as shown in FIG. 6, the grooves 21a into which the barb structures 22a fit are formed on the outer circumferential surface of the projected part 21. In the example shown in FIG. 6, the groves 21a each having a triangular shape in cross-section are circularly formed along the whole circumference of the outer peripheral surface of each projected part 21.

By fitting, into the recessed part 22 of the one component 20, the projected part 21 of the other component 20, the two components 20 are assembled together. When the recessed part 22 is to be fitted into the projected part 21, each barb structure 22a formed on the inner circumferential surface of the recessed part 22 bends so as to come in close contact with the inner circumferential surface of the recessed part 22. Then, after fitting of the projected part 21 into the recessed part 22 is completed, each barb structure 22a formed on the inner circumferential surface of the recessed part 22 fits into each groove 21a formed on the outer circumferential surface of the projected part 21.

As described above, in the method of manufacturing a vehicle according to the second embodiment, the barb structures 22a protruding inward and towards the root side of the recessed part 22 are formed on the inner circumferential surface of the recessed part 22 formed on the assembly surface of the one component 20. Further, the grooves 21a into which the barb structures 22a fit are formed on the outer circumferential surface of the projected part 21 formed on the assembly surface of the other component 20.

Therefore, when the one component 20 and the other component 20 are assembled together by fitting the projected part 21 into the recessed part 22, each barb structure 22a formed on the inner circumferential surface of the recessed part 11 fits into each groove 21a formed on the outer circumferential surface of the projected part 12. Accordingly, it is possible to make the projected part 21 and the recessed part 22 that are fitted to each other hard to come off from each other.

That is, in the method for manufacturing a vehicle according to the second embodiment, it is possible to assemble the components of the vehicle to each other without having to fasten any screws and the components in the fitting structure are hard to come off from each other.

Other configurations are the same as those of the first embodiment and thus detailed explanations thereof are omitted.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a vehicle in which a projected part formed on an assembly surface of one component and a recessed part formed on an assembly surface of the other component are fitted to each other so that the one component and the other component are assembled together, the method comprising:
forming a barb structure protruding outward and towards the root side of the projected part on an outer circumferential surface of the projected part; and
forming a groove into which the barb structure fits on an inner circumferential surface of the recessed part.

2. A method for manufacturing a vehicle in which a projected part formed on an assembly surface of one component and a recessed part formed on an assembly surface of the other component are fitted to each other so that the one component and the other component are assembled together, the method comprising:
forming a barb structure protruding inward and towards the root side of the recessed part on an inner circumferential surface of the recessed part; and
forming a groove into which the barb structure fits is formed on an outer circumferential surface of the projected part.

3. The method for manufacturing the vehicle according to claim 1, wherein, when the one component and the other component are to be assembled together, the projected part is cooled.

4. The method for manufacturing the vehicle according to claim 1, wherein, when the one component and the other component are to be assembled together, the recessed part is heated.

5. The method for manufacturing the vehicle according to claim 1, wherein a plurality of the barb structures are arranged in a depth direction of the recessed part or in a height direction of the projected part.

6. The method for manufacturing the vehicle according to claim 2, wherein, when the one component and the other component are to be assembled together, the projected part is cooled.

7. The method for manufacturing the vehicle according to claim 2, wherein, when the one component and the other component are to be assembled together, the recessed part is heated.

8. The method for manufacturing the vehicle according to claim 2, wherein a plurality of the barb structures are arranged in a depth direction of the recessed part or in a height direction of the projected part.
